(19) United States
(12) Patent Application Publication
(10) Pub. No.: US 2006/0056949 A1
(43) Pub. Date: Mar. 16, 2006

(54) Transport vehicle for aircraft

(76) Inventor: Kersten Eckert, Erftstadt (DE)

Correspondence Address: CANTOR COLBURN, LLP, 55 GRIFFIN ROAD SOUTH, BLOOMFIELD, CT, 06002, US

(21) Appl. No.: 10/941,268

(22) Filed: Sep. 15, 2004

(51) Int. Cl. B60B 29/00

(52) U.S. Cl. 414/427

(57) ABSTRACT

The invention applies to a vehicle for towing and shunting aircraft, which can raise and lift an aircraft undercarriage, and which has at least one wheel or caterpillar track on either side of the longitudinal axis of the vehicle. The wheels or caterpillar tracks on one side are driven independently of those on the other side. The vehicle can be steered by using different rpm for the wheels or caterpillar tracks.

The invention concerns a vehicle for towing and shunting aircraft that can engage and lift the undercarriage of an aircraft, and which has at least one wheel or caterpillar track on either side of its longitudinal axis.

In order to shunt airplanes or other aircraft around an airport, it is necessary to fasten a drawbar to the nose-wheel assembly of an airplane and then pull or push the aircraft using a vehicle. However, there are several disadvantages to using a drawbar to move an aircraft. Fastening and unfastening the drawbar between the aircraft and the vehicle requires considerable time and effort. In addition, it is necessary to use a specially adapted drawbar for each aircraft type. What is more, maneuvering the aircraft using a drawbar is difficult and restricted. And finally, the towing vehicle must be relatively heavy in order to produce sufficient friction between the wheels of the towing vehicle and the surface on which it maneuvers. Using a drawbar lengthens the towing connection. Towing vehicles of this type have limited use in crowded conditions.

There are also several kinds of existing aircraft towing vehicles without drawbars. These towing vehicles usually have a U-shaped recess in the rear with a hoisting apparatus for lifting the aircraft's nose-wheel assembly. The aircraft's nose-wheel assembly is lifted using this hoisting apparatus and attached to it, so that the towing power of the towing vehicle is transferred to the aircraft. These towing vehicles exhibit better maneuverability than drawbar systems.

The towing vehicle's hoisting apparatus engages directly with a corresponding recess on the linkage assembly of the nose-wheel assembly, with an appropriately shaped linkage unit on the wheels themselves, or one found on the wheel of the nose-wheel assembly. Towing vehicles that engage the nose-wheel assembly via the linkage unit have the disadvantage of being restricted to use with aircraft types that have suitably shaped linkage units and thus cannot be used universally, regardless of aircraft type. Towing vehicles that engage with and lift the wheel or wheels of the nose-wheel assembly of an aircraft can be used regardless of the aircraft type. For example, there are towing vehicles that draw the wheel of the nose-wheel assembly up a slanted plane onto a turntable or bearing plate. In addition, there are towing vehicles that clamp onto the nose wheels using hydraulically controlled telescope arms, and then lift the nose wheels to the required height from the ground by means of lifting kinematics.

Existing types of towing vehicles have a steerable front axle and a rear axle that is also steerable and which carries the main drawbar load of the raised nose-wheel assembly. In order to prevent the drawbar load exerted by the nose-wheel assembly from lifting the steerable front axis during the towing process, the towing vehicle is designed so that the additional load-point of the nose-wheel assembly lies in front of the rear axle. Also, in order to avoid the front axle being lifted, the towing vehicles are designed to ensure that as much weight as possible is placed on the front axle. In addition, the greatest possible length, in combination with the widest possible distance between axles, helps avoid the front wheels being lifted. Regardless of the maximum steering lock angle of the steerable wheels and the axis-center distance, dual axle towing vehicles with front steering axles have a minimum turn radius that determines and limits the maneuverability of the towing vehicle.

The limited maneuverability of existing towing vehicles is a disadvantage, particularly when shunting aircraft in crowded hangars.

There are single-axle, motor-driven towing vehicles to shunt very small and light aircraft, such as single-motor recreational aircraft that are controlled by hand with a steering rod. With this type of towing vehicle, the nose-wheel assembly of the aircraft is lifted by the towing vehicle in such a way that the load point coincides with the axis of the towing vehicle. These towing vehicles sometimes have a free-pivoting stand wheel in front of the driven axis. In towing vehicles of this type, the nose-wheel assembly is drawn up onto the towing vehicle in a way that places the load point between the driven axle and the free-pivoting stand wheel. An electric or gasoline motor is intended as the primary driver for the towing vehicle. The towing vehicle is controlled by means of a steering rod located, for example, in the forward area of the towing area. This is used by the operator to steer the vehicle in the intended direction. It is a disadvantage that during shunting, the operator has to exert great force in order to overcome frictional force between the wheels of the towing vehicle and the ground.

In addition, this type of towing vehicle can only be used for aircraft with low nose-wheel assembly weight and is therefore restricted to small and light aircraft. If the drawbar load of the nose-wheel assembly lifted by the towing vehicle is too heavy, it becomes almost impossible for the operator to steer the towing vehicle.

Given the present state of technological development, the aim of the invention described here is to produce a vehicle for transporting aircraft that can be used regardless of the type and construction of the aircraft being transported, one that does not put undue strain on the aircraft, provides for automated loading of the aircraft, displays better maneuverability compared to the current state of the art, is user-friendly and robust, and can be produced economically.

These objectives are met with a type of vehicle in which the wheels or caterpillar tracks on one side are driven independently of those on the other, it being possible to steer the vehicle by means of different rotational speeds of the wheels or caterpillar tracks.

The following is a description of a wheeled vehicle. All explanations naturally apply to caterpillar-tracked vehicles a swell. In addition to the driven wheels, the vehicle also has at least one non-driven stand wheel, which is located in a suitable position and pivots freely around a vertical axle. However, it is also possible to have a vehicle without this type of stand wheel. Even though the invention is described below using the example of a vehicle with one drive wheel on either side of the longitudinal axis of the vehicle, and one freely pivoting stand wheel, it is naturally also possible to have a vehicle where there are several drive wheels on either side of the longitudinal axis, as well as several freely-pivoting stand wheels in any number of suitable positions.

The vehicle's two driven wheels can be driven independently. The wheel drives are designed to allow rotation at the same or different speeds, so that the relative rpm of the two driven wheels can be adjusted as required. The rpm range of each drive wheel can be continuously adjusted from stationery to maximum rpm nₘₐₓ. It can also be an advantage that the direction of rotation of the drive wheels is reversible. Individual drive for drive wheels, adjustability of velocity and direction of rotation, and the attached, freely pivoting stand wheel ensure a full range of maneuverability for the vehicle that is the subject of the invention. If the speed ratio of both drive wheels is 1, the vehicle will move in a straight line. The vehicle can be driven in varying curves by changing the speed ratio. If one drive wheel is stationary while the drive wheel on the other side of the vehicle is in motion, the vehicle describes a turn that has the support point of the stationary wheel as its pivotal point. When the drive wheels rotate in opposite directions at the same rpm, the vehicle turns around the axial midpoint of the axle of both drive wheels. The freely pivoting stand wheel adjusts without resistance to the vehicle's direction of movement.

The transport vehicle for towing aircraft to which the invention applies is also suited for towing any other vehicles. It could readily be used for passenger cars, trucks, construction equipment, trailers, mobile homes, etc. The vehicle could also be used to transport long loads, such as pipes, beams, or tree trunks.

In one version of this invention, the wheels or caterpillar tracks are driven by linear motors. Linear motors enable very precise rotation of the drive wheels with direct vehicle response and sufficient power. Linear motors also require no heating up or after-running.

One especially useful version of this invention is the linear-motor hub motor. These hub motors can be used with great advantage in the area of drive-wheel hubs, as they do not take up any constructed space when shunting aircraft. In addition, no gear unit or other transmission unit is needed to transmit power from the drive engine to the drive wheels. The drive units of the vehicle described in the invention therefore save constructed space, which is why the vehicle shows a very high degree of flexibility when it comes to its use with different aircraft types and designs. The absence of gear units and other transmission units lowers vehicle cost.

Another version of the invention has the advantage that the vehicle is steered by remote control via a wireless or cable connection. The vehicle can be operated exclusively via remote control or alternatively and additionally from a built-in operator's position. By equipping the vehicle with a remote control, the operator of the vehicle has the advantage of freely choosing his position relative to the vehicle and to the aircraft that has to be moved, which considerably improves the overview of shunting operations. The free choice of position allows the operator the possibility of performing difficult shunting operations alone, without the assistance of persons standing outside and giving directions. For example, the operator can position himself at the ends of the wings or the tail of an aircraft that is being shunted during difficult shunting operations in crowded aircraft hangars. By providing the vehicle with remote control, it can be used in a highly flexible manner.

In another version of the invention, the vehicle has a hoisting unit to raise a wheel assembly. It is possible to affix a clamping unit to the hoisting unit in order to clamp onto the wheel of the aircraft to be lifted. Because it can clamp onto the wheel of the vehicle that is to be lifted, the vehicle described in the invention is not limited to use with a certain wheel design, but can be used individually for all aircraft types with certain wheel sizes. The clamp unit engages the nose wheel under its rotation axis, for example. An aircraft with a tail wheel can be lifted by that wheel. The main landing gear can also be engaged.

The hoisting unit has the advantage of having an essentially U-shaped recess for engaging the landing gear. The hoisting unit has the advantage of consisting of two plates or plate-like elements with a gap between them, where the clamping unit is positioned. This means that the clamping unit is guided and supported by the plates of the hoisting unit. The clamping unit has the advantage of being essentially pincer-shaped, and in another version of the invention, it is operated by means of a guide bar. The guide bar can be placed between the plates of the hoisting unit. A hoisting unit with this type of clamping unit has the advantage of being relatively flat and requiring very little constructed space. The support force exerted by the raised landing gear on the clamping unit is transferred directly into the hoisting unit via the clamping unit, which is guided and supported by the hoisting unit, which means that the clamping unit can be made of relatively light material. The clamping unit consists of pincer-shaped clamping elements which are held in an open position of initial tension by a spring.

By activating the guide bar, the clamping elements are closed against the initial tension, fixing the wheel of the aircraft. The guide bar is pushed out in order to open the clamping unit, when the clamping elements reopen due to the initial tension of the spring. The clamping elements can also be kept in a closed position through initial spring tension and opened through the action of the guide bar. It is also possible to provide the vehicle with a hoisting unit that clamps onto the landing gear of the aircraft.

One version of the invention has the advantage of being provided with a lever mechanism that activates both the guide bar and the hoisting unit. The lever mechanism is designed to move the guide bar first, until the clamping unit is closed, after which an additional movement of the lever mechanism raises the entire hoisting unit including the clamping unit that is a part of it. This ensures that the aircraft is not lifted until the landing-gear wheel by which it will be hoisted is securely engaged by the vehicle.

Further advantages and characteristics of the invention are seen in the following description of a non-specific version. They show the following:

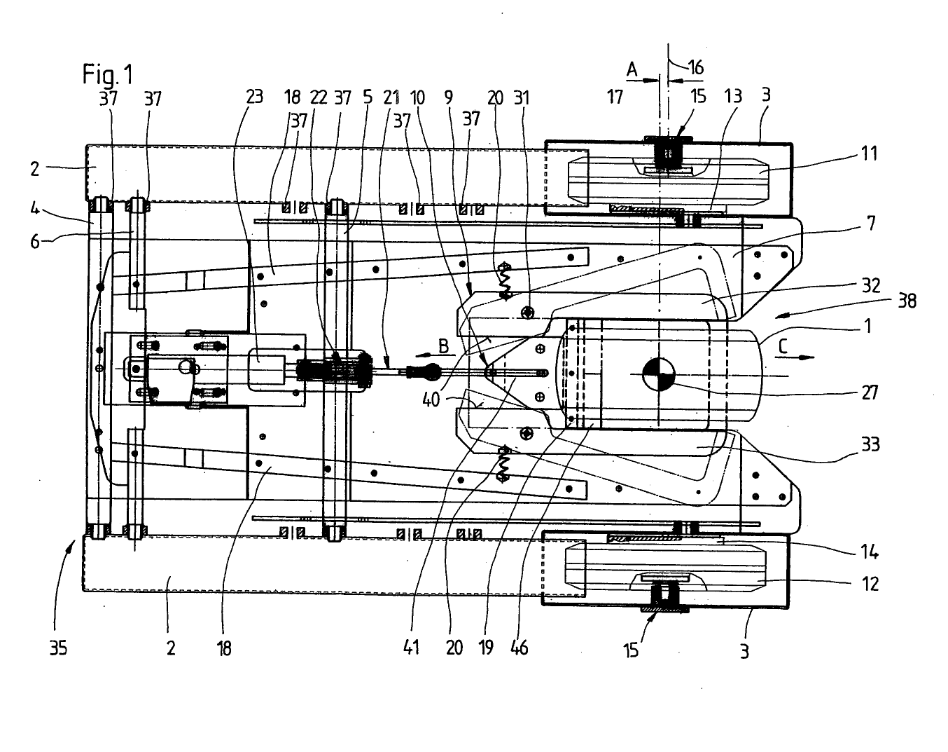

FIG. 1A diagram of a vehicle with an aircraft landing wheel and

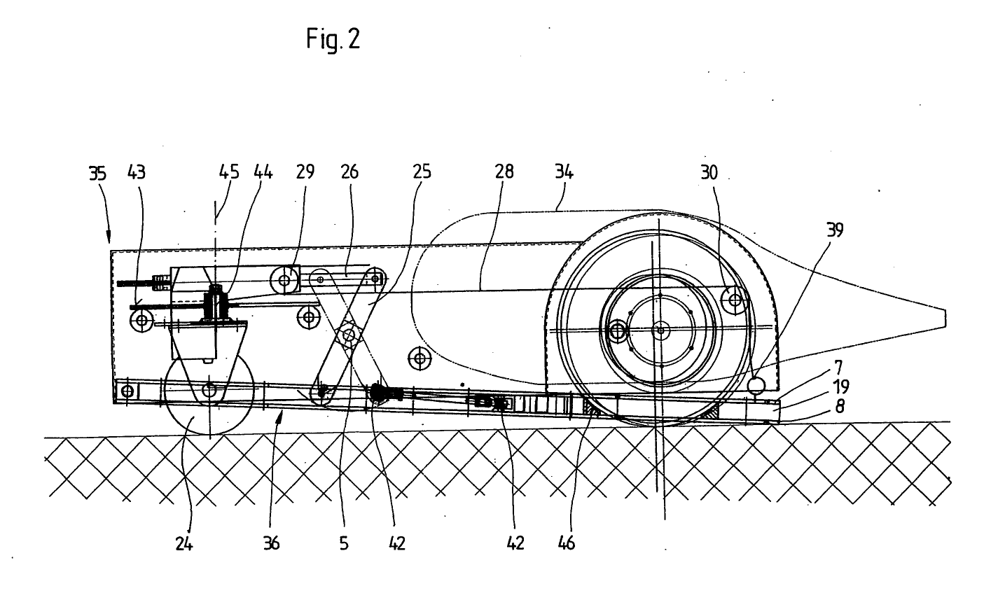

FIG. 2 the aircraft seen in FIG. 1 in a lateral-view diagram.

The aircraft consists essentially of an undercarriage 35, a lifting unit 36, a clamping unit 9, and a lever mechanism 22.

The undercarriage 35 shows two longitudinal supports 2 and a front, middle, and rear transverse struts 4, 5, 6. Wheel arches 3 are attached to the longitudinal supports 2. Both the longitudinal supports 2 and the wheel arches 3 are of welded, plate construction. The transverse struts 4, 5, 6 are stored in sheaths attached to the longitudinal supports 2. The front transverse strut 4 can pivot on its longitudinal axis. In wheel arches 3, a right drive wheel 11 and a left drive wheel 12 are inserted into suitable wheel bearings. Drive wheels 12, 12 are driven by hub wheels 13, 14. Hub motors 13, 14 are shown as linear motors. Hub motors 13, 14 drive the drive wheels 11, 12 directly, without the interposition of a gear unit.

The lifting element 36 has an upper plate 7 and a lower plate 8. Both the upper plate 7 and the lower plate 8 are provided with an essentially U-shaped recess 38, into which the nose-wheel 1 of the aircraft being transported is placed. The upper plate 7 and the lower plate 8 are affixed to the front transverse strut 4 and kept apart and stabilized by the longitudinal struts 18 and transverse struts 19. In the area on the nose-wheel side, the lifting unit 36 has fasteners 39, for example in the form of eyebolts, to which the chains of a chain-drive 28 are attached. The transverse struts 19 interact with the wheel arches 3, in this way serving simultaneously as vertical guide elements in moving hoisting unit 36.

The clamping unit 9 has a left clamp arm 32 and a right clamp arm 33. The clamp arms 32, 33 are essentially L-shaped, arranged in pincer form, and placed, by means of a bearing 31, between the upper plate 7 and the lower 8 of the lifting unit. The gap between the upper plate 7 and the lower plate 8 is adjusted to the dimensions of the clamp arms 32, 33, so that the hoisting unit both carries and supports the clamp arms 32, 33. The clamp arms 32, 33 have guideways 40 that interact with a guide bar 10. Compression springs 20 are placed between the clamp arms 32, 33 and the longitudinal struts 18, and the springs hold the clamp arms 32, 33 of the clamping unit 9 in an open position (shown in dashed outline in FIG. 1). Moving the guide bar 10 in the direction shown by arrow 8, pushes the guide bar through the guideways of the clamp arms 32, 33, causing the clamp arms 32, 33 to close against the force of the compression springs 20 in the position (continuous line) shown in FIG. 1.

The guide bar 10 is provided with a driving rod 21. The driving rod 21 is connected via one end-joint 42 with the guide bar 10 and via a second end-joint 42 with a lever 25. The joint 42 on the guideway side is fastened to a spike that is inserted successively into the slotted holes 41 of the guide bar 10. The lever 25 is attached to the rear transverse strut 5 and pivots around its longitudinal axis. At its end opposite to the driving rod 21, the lever 25 is connected to the piston rod 26 of a hydraulic cylinder 23, which is permanently fixed to one of the base-plates 43 placed on the middle transverse strut 6. In addition, the chain drive 28 is affixed to the end of the lever 25 connected to piston rod 26. The chain drive 28 runs from the attachment point on lever 25 via a front deflection roller 20 and a rear deflection roller 20 to the fasteners on the lifting unit 36.

A stand wheel is placed on a base-plate 43. The stand wheel 24 pivots around a vertical axis 45 by means of a bearing 44. Battery- or rechargeable battery units to provide a power supply, which are not shown, are placed in the area of the base-plate 43.

The axis 16 of drive wheels 11, 12 and the clamping unit 9 are placed in positions relative to each other so that a lateral axis 17 that passes through the load support point 27 (the point at which the drawbar load of the aircraft is exerted on the vehicle) parallel to axis 16 is displaced toward axis 16 by gap A in the direction of the front stand wheel 24. In order to minimize, as far as possible, the force exerted on the nose-wheel assembly during shunting, it is useful to design the vehicle so that a vertical line running through support point 27 intersects the axis 16 of the drive wheels 11, 12. That minimizes the force and torque exerted on the nose wheel assembly when turning the vehicle. However, in order to securely absorb the support force exerted on the aircraft, it is necessary to distribute this between the drive wheels 11, 12 and the stand wheel 24. As described above, this is achieved by having the support point lie in front of axis 16 of the drive wheels 11, 12, the distance being that of gap A, in the direction of stand wheel 24. The larger the selected gap A is, the more securely the extra load exerted by the aircraft on the vehicle will be distributed among all three wheels. However, as gap A increases, the force and torque exerted on the nose wheel assembly during aircraft shunting also increase.

In order to make the invention more understandable, the following is a description of the process of coupling an aircraft to the vehicle. The vehicle is driven backwards with the open clamping unit 9 (shown in dashed outline) in the direction of arrow C toward the nose wheel 1 of a parked aircraft. From FIG. 1, it can be seen that the guide bar 10 with open clamp arms 32, 33 is in a rear (moved in the direction of the clamp arms) position. In this condition, the lever 25 is in the position shown in dashed outline in FIG. 2; the piston rod 26 has been inserted into the hydraulic cylinder 23. This means that the lifting unit 36 has been lowered by chain drive 28, which is extended in this position. In this condition, the vehicle is driven backwards until the front edge of the nose wheel 1 contacts the front attachment of the hoisting unit 36. The vehicle is halted in this position, and the piston rod 26 of the hydraulic cylinder 23 is extended. Extending the piston rod 26 causes the lever 25 to pivot around the rear transverse brace 5. The pivoting movement of the lever 25 moves the driving rod 21 in the direction of arrow B. The movement of the driving rod 21 moves the spikes inserted in the slotted holes 41 further along in the slotted holes 41 in the direction of the stand wheel 24. When the spikes lay against the stand-wheel end of the slotted holes 41, the displacement of the driving rod 21 causes a displacement of the guide bar 10 in the direction of arrow B. This displacement of the guide bar 10 causes the clamp arms 32, 33 of the clamping unit 9 to close against the compression tension of the springs 20 (shown drawn through in FIG. 1). At the same time, the pivoting movement of lever 25 around the rear transverse strut 5 shortens the length of the chain drive 28. The chain drive 28 is wound around the deflection rollers 29 and 30, so that the hoisting unit 36 is raised due to the movement of the chain-drive 28. The lifting movement of the hoisting unit 36 raises the nose wheel 1 of the aircraft from the ground, the wheel having been securely grasped by the closed clamp arms 32, 33, of the lifting unit. The entire front drawbar load of the aircraft is now transferred to the clamping unit 9 and hoisting unit 36 of the vehicle. The aircraft can now be towed and shunted using the vehicle.

The plate-like construction of the hoisting unit 36 and the essentially U-shaped form of the undercarriage 35 create an open space in the inside of the vehicle which is also big enough to accommodate the aerodynamic cladding of the nose wheel.

The vehicle can be controlled from an operator's cabin, which is not shown. Alternatively, it can be run by remote control. The remote control unit can be connected to the vehicle via radio or cable connection. It is also possible to steer the vehicle from both an operator's cabin on the vehicle and a remote control unit.

### LIST OF REFERENCE NUMBERS

1 Nose wheel
2 Longitudinal supports
3 Wheel arch
4 Front transverse strut
5 Rear transverse strut
6 Middle transverse strut
7 Upper plate
8 Lower plate
9 Clamping unit
10 Guide bar
11 Right drive wheel
12 Left drive wheel
13 Right hub motor
14 Left hub motor
15 Wheel bearing
16 Drive wheel axis
17 Transverse axis load point
18 Longitudinal strut
19 Transverse strut
20 Compression spring
21 Driving rod
22 Lever mechanism
23 Hydraulic cylinder
24 Stand wheel
25 Lever
26 Piston rod
27 Support point
28 Chain drive
29 Front deflection roller
30 Rear deflection roller
31 Clamp bearing
32 Left clamp arm
33 Right clamp arm
34 Nose wheel cover
35 Undercarriage
36 Hoisting unit
37 Sheath
38 U-shaped recess
39 Fastener
40 Guideway
41 Slotted holes
42 Joint
43 Baseplate
44 Bearing
45 Vertical axis
46 Front attachment
A Gap between wheel axle/support point
B Device for closing guide bar
C Backward driving direction

1. A vehicle for towing and shunting aircraft that can lift the undercarriage of an aircraft and raise it from the ground, comprising:
at least one wheel or caterpiller track on either side of a longitudinal axis
wherein the wheels or caterpillar undercarriage on one side can be driven independently of those on the other side, and the vehicle can be steered by running the wheels or caterpillar track at different rpm.

2. A vehicle of the type specified in claim 1, wherein the wheels or caterpillar tracks are driven by linear motors.

3. A vehicle of the type specified in claim 1, wherein the linear motors are hub motors.

4. A vehicle of the type specified in claim 1, wherein it is possible to steer the vehicle by remote control via wireless or cable connection.

5. A vehicle of the type specified in claim 1, wherein the vehicle includes a hoisting unit to lift the undercarriage of the aircraft.

6. A vehicle of the type specified in claim 5, wherein the hoisting unit is equipped with a clamping unit for engaging a wheel of the aircraft to be lifted.

7. A vehicle of the type specified in claim 5, wherein the hoisting unit includes an essentially U-shaped recess for engaging the undercarriage.

8. A vehicle of the type specified in claim 5, wherein the hoisting unit comprises two plates with a gap between them.

9. A vehicle of the type specified in claim 8, wherein a clamping unit is located between the plates.

10. A vehicle of the type specified in claim 9, wherein the clamping unit has an essentially pincer-shape.

11. A vehicle of the type specified in claim 6, wherein the clamping unit is moved by a guide bar.

12. A vehicle of the type specified in claim 11, wherein the vehicle includes a lever mechanism that simultaneously moves both the guide bar and the lifting unit.

13. A use of a vehicle of claim 1 for towing and shunting motor vehicles and trailers and for handling long loads.
